(19) United States
(12) Patent Application Publication
(10) Pub. No.: US 2014/0137894 A1
(43) Pub. Date: May 22, 2014

(54) PROCESS FOR REMOVING SUBSTANCES FROM SUBSTRATES

(71) Applicant: DYNALOY, LLC, Kingsport, TN (US)

(72) Inventors: Richard Dalton Peters, Kingsport, TN (US); Travis Acra, Ingalls, IN (US); Spencer Erich Hochstetler, Kingsport, TN (US)

(73) Assignee: DYNALOY, LLC, Kingsport, TN (US)

(21) Appl. No.: 13/682,974

(22) Filed: Nov. 21, 2012

(51) Int. Cl. B08B 3/10; B08B 7/00

(52) U.S. Cl. CPC B08B 3/10; B08B 7/0014
USPC 134/19; 134/26

(57) ABSTRACT

A process is described that is useful for removing organic substances from substrates, for example, electronic device substrates such as microelectronic wafers or flat panel displays. A process is presented for applying a minimum volume of a chemical stripping composition as a coating to the inorganic substrate whereby sufficient heat is added and the organic substances are completely removed by rinsing. The process may be suitable for removing and, in some instances, completely dissolving photoresists of the positive and negative varieties, and especially negative dry film photoresist from electronic devices.

### STATEMENT OF JOINT DEVELOPMENT

This invention was created pursuant to a joint development agreement between Eastman Chemical Co. and EV Group. The aforementioned joint development agreement was in effect on or before the date the claimed invention was made, and the claimed invention was made as a result of activities undertaken within the scope of the joint development agreement.

### BACKGROUND

Various polymers may be used in the manufacture of electronic devices, including, for instance, photoresists and organic-based dielectrics. Photoresists, for example, may be used throughout semiconductor device fabrication in photolithographic operations. A photoresist may be exposed to actinic radiation through a photomask. Where a positive-acting resist is used, exposure may cause a chemical reaction within the material resulting in a solubility increase in aqueous alkali, allowing it to be dissolved and rinsed away with developer. Where a negative-acting resist is used, cross-linking of the polymer may occur in the exposed regions while leaving unexposed regions unchanged. The unexposed regions may be subject to dissolution and rinsing by a suitable developer chemistry. Following development, a resist mask may be left behind. The design and geometry of the resist mask may depend upon the positive or negative tone of the resist; positive tone resist may match the design of the photomask, while a negative tone resist may provide a pattern that is opposite the photomask design.

Photoresists are used extensively in the packaging of microelectronic devices. In wafer level packaging, solder is applied directly to wafers that have completed the fabrication of the microelectronic devices but have not been diced into individual chips. A photoresist is used as the mask to define the placement of the solder on the wafers. After solder is deposited onto the wafer, the photoresist must be removed before the next step in the packaging process can occur. Typically in wafer level packaging, the photoresist is very thick, greater than 50 μm and sometimes as thick as 120 μm. The photoresist can be positive or negative, and can be applied either as a liquid or a dry film. In wafer level packaging, the use of thick dry film negative photoresist is common.

Due to the thickness and cross-linked nature of thick dry film negative photoresist, the removal of this material after solder deposition can be difficult. The typical process for removing thick dry film negative photoresist in wafer level packaging applications is immersion of the wafer in formulated organic solvent-based mixtures for extended periods of time, often longer than 1 hr. Typically, 25 wafers are immersed in a tank containing the formulated solvent-based mixture for a sufficient time to completely remove the photoresist film. After a sufficient period of time, the wafers are transferred to additional tanks for rinsing, where the rinsing media may include water or isopropanol. Additional wafers are then processed in the same tank reusing the same formulated mixture, and the process is repeated for as long as the formulated mixture is capable of sufficiently removing the photoresist completely from the wafer. As wafers are processed in the tank, the formulated mixture is constantly changing due to the incorporation of photoresist as it is removed from the wafers and due to degradation of components in the mixture. Once the mixture is no longer capable of sufficiently removing resist from wafers, the tank is drained and cleaned, and fresh formulation is added to the tank.

Disadvantages of immersion-based cleaning of thick dry film negative photoresist include long processing times, large volumes of chemicals required per wafer to sufficiently remove the photoresist, and variability in cleaning performance due to the constantly changing composition of the mixture.

### SUMMARY

This summary is provided to introduce simplified concepts of processes for removing substances from substrates such as, for example, photoresist removal applications. Additional details of example processes are further described below in the Detailed Description. This summary is not intended to identify essential features of the claimed subject matter, nor is it intended for use in determining the scope of the claimed subject matter.

According to a first embodiment, the present invention concerns a process for removing a substance from a substrate comprising:

a. providing a substrate having a first side on which is disposed a substance and a second side;

b. contacting the first side of the substrate with a stripping composition to a thickness sufficient to coat at least a portion of the first side of the substrate;

c. heating the substrate, stripping composition or both to a temperature and for a time sufficient to release the substance from at least a portion of the substrate;

d. agitating the substrate through a mechanical, sonic, or electrical force to substantially remove the stripping composition and released substance,

wherein at least a portion of said second side is not exposed to the stripping composition.

Another embodiment concerns a process for removing a substance from a substrate comprising:

a. providing a substrate having a first side on which is disposed a substance and a second side;

b. contacting the first side of the substrate with a stripping composition to a thickness sufficient to coat a least a portion of the first side of the substrate and for a time sufficient to release the substance; and

c. agitating the substrate through a mechanical, sonic, or electrical force to substantially remove the stripping composition and released substance,

wherein at least a portion of said second side is not exposed to the stripping composition.

Yet another embodiment concerns a process for rinsing a substrate comprising:

a. providing a substrate having a first side on which is disposed a substance and a second side;

b. removing the substance from the substrate;

c. contacting the first side of the substrate with an aqueous base solution;

d. contacting the first side of the substrate with a rinsing agent effective to remove said aqueous base solution from the substrate; and

e. drying said substrate,

wherein a.-e. occur in a single bowl, and

at least a portion of said second side is not exposed to the aqueous base solution composition.

Still another embodiment concerns process for rinsing a substrate comprising:

a. providing a substrate having a first side on which is disposed a substance and a second side;

b. removing the substance from the substrate;

c. contacting the first side of the substrate with an aqueous acid solution;

d. contacting the substrate with a rinsing agent effective to remove said aqueous acid solution from the substrate; and

e. drying said substrate,

wherein a.-e. occur in a single bowl, and

at least a portion of said second side is not exposed to the aqueous acid solution composition.

A process for rinsing a substrate comprising:

providing a substrate having a first side on which is disposed a substance and a second side;

a. removing the substance from the substrate;

b. contacting the substrate with an aqueous base solution;

c. contacting the substrate with a rinsing agent;

d. contacting the substrate with an aqueous acid solution;

e. contacting the substrate with a rinsing agent; and

f. drying said substrate,

wherein at least b.-f. occur in a single bowl, and

at least a portion of said second side is not exposed to the aqueous base solution or the aqueous acid solution composition.

### BRIEF DESCRIPTION OF THE DRAWINGS

FIG. 1 shows a liquid temperature and liquid-heater separation vs. time for top-down convective heating with a heater temperature of 250° C.;

FIG. 2 shows a liquid temperature vs. time for top-down convective heating with a heater temperature of 150° C.;

FIG. 3 shows a liquid temperature vs. time for bottom-up conductive heating with a heater temperature of 115° C.; and

FIG. 4 shows a liquid temperature vs. time for top-down radiative heating.

### DETAILED DESCRIPTION

The present invention concerns a process useful for removing photoresist (e.g. organic substances) from substrates such as, for example, polymeric organic substances from inorganic substrates, such as wafer and wafer level packaging applications. The process addresses disadvantages with using immersion based cleaning to remove, for example, thick dry film negative photoresist from wafers.

According to an embodiment, the process according to the present invention includes various combinations of process steps which can include one or more process steps such as providing a substrate, contacting the substrate with a stripping composition, heating the substrate, stripping composition or both to a temperature and for a time sufficient to release the substance from at least a portion of the substrate, agitating the substrate through a mechanical, sonic, or electrical force to substantially remove the stripping composition and released substance. The process can also include rinsing with a rinsing agent or via a series of rinsing steps which can also include a combination of steps such as contacting the substrate with an aqueous base solution, contacting the substrate with a rinsing agent, contacting the substrate with an aqueous acid solution, contacting the substrate with a rinsing agent, and drying the substrate, and contacting the substrate with a drying agent. According to an embodiment, the stripping composition is fresh, has not been used previously, and does not contain any recycled components. However, according to certain embodiments, the stripping composition may be reused. Moreover, according to certain embodiments, all or any combination of the process steps may be performed in a single bowl.

The processes of the present disclosure may have application in the manufacture of a variety of devices including but not limited to semiconductor wafers, RF devices, hard drives, memory devices, MEMS, photovoltaics, Displays, LEDs, wafer level packaging, solder bump fabrication and memory resistor fabrication. Other processes in which the cleaning methods as disclosed may also be useful, include without limitation removal of photoresists (BEOL, FEOL), post-metallization, or post etch residues, post implantation residues, lift-off (controlled corrosion), rework of passivation layers, and photoresist rework.

The term “coating” is defined as a method for applying a film to a substrate such as spray coating, puddle coating, or slit coating. The term “release” or “releasing” relates to removal of the substance form the substrate and is defined to include dissolution of the substance. The term “residue” includes the photoresist residues before etching and etch residues that include the photoresist byproducts of the etching process, deposits on the solder caps, and other organometallic residues unless specific reference is made to the type of residue. The terms “stripping”, “removing”, and “cleaning” are used interchangeably throughout this specification. Likewise, the terms “stripping composition”, “stripping solution”, and “cleaning composition” are used interchangeably. The indefinite articles “a” and “an” are intended to include both the singular and the plural. All ranges are inclusive and combinable in any order except where it is clear that such numerical ranges are constrained to add up to 100%, and each range includes all the integers within the range. The terms “weight percent” or “wt %” mean weight percent based on the total weight of the composition, unless otherwise indicated.

According to an embodiment, the process includes coating a wafer having a substance on at least one side, such as a thick dry film negative photoresist, with a volume of a stripping composition. According to an embodiment, the stripping composition is fresh, has not been used previously, and does not contain any recycled components. However, in certain embodiments, the stripping composition can be re-used. Moreover, according to an embodiment, the photoresist film can be patterned with holes, inside which solder has been plated. The solder may be any known solder, for example, the solder can include but is not limited to an alloy of Pb and Sn, Sn and Ag, or Cu pillars with a solder cap.

Stripping compositions useful with the processes described herein include formulated solvent-based compositions that dissolve the targeted substance or cause the targeted substance to be released from the substrate. Example stripping compositions include but are not limited to compositions comprising a polar aprotic solvent, an amine, and a quarternary ammonium hydroxide. The polar aprotic solvent can be but is not limited to dimethyl sulfoxide, dimethylformamide, dimethylacetamide, 1-formylpiperidine, dimethylsulfone, n-methylpyrrolidone or mixtures thereof. The amine can be but is not limited to dimethylaminoethanol, diglycolamine, aminoethylethanolamine, diethanolamine, monoisopropanolamine or mixtures thereof. The quarternary ammonium hydroxide can be but is no limited to tetramethylammonium hydroxide, tetramethylammonium hydroxide pentahydrate, tetrabutylammonium hydroxide, benzyltrimethylammonium hydroxide, tetrapropylammonium, dimethyldipropylammonium hydroxide, tetraethyl ammonium hydroxide, dimethyldiethyl ammonium hydroxide or mixtures thereof. Additionally, additives may be included such as metal corrosion inhibitors, or surfactants. Other stripping compositions may also be used with the present processes.

The volume of stripping composition may be such that it is sufficient to coat at least a portion of a first side (or side upon which the substance to be removed is located) of the substrate in a manner to remove or release the thick dry film negative photoresist on the covered portion. According to other embodiments, the volume of stripping composition may be sufficient to coat the entire first side of the wafer in a manner to remove or release the thick dry film negative photoresist along the entire surface. For example, according to certain embodiments, the stripping composition is applied to provide a coating on top of the wafer that is 15 mm thick or more. In other certain embodiments the stripping composition is applied to provide a coating on top of the wafer that is less than 15 mm thick or less than 10 mm thick. Alternatively, the stripping composition is applied to provide a coating on top of the wafer that is from about 0.5 mm thick to about 15 mm thick or from about 1.0 mm thick to about 10 mm thick. In other preferred embodiments, the stripping composition is applied to provide a coating on top of the wafer that is less than 5 mm thick, or less than 4 mm thick, or less than 3.5 mm thick, or less than 3 mm thick, or less than 2.5 mm thick, or less than 2 mm thick. In other preferred embodiments, the stripping composition could also be applied at a thickness of from about 0.5 mm to about 5.0 mm; from about 0.6 mm to about 3 mm; or from about 0.7 mm to about 1.5 mm. Alternatively, for a 300 mm wafer, the volume of stripping composition used per wafer may be less than 500 mL, or less than 400 mL, or less than 300 mL, or less than 250 mL, or less than 200 mL, or less than 150 mL, or less than 100 mL, or less than 75 mL.

According to an embodiment, the wafer can be held by a chuck that can rotate. The chuck can be such that the backside of the wafer is in contact almost completely with the same material, for example air, or an insulating polymer such as PEEK or PTFE.

According to an embodiment, the substrate may be coated with the stripping composition by any known means, such as for example, by spin-coating, spray coating, puddle coating, or slit coating. Spin-coating the composition may involve dispensing the material at the center of a substrate, and operating the equipment at a low rate of circular motion speed (i.e. 100 revolutions per min, rpm, or less). Liquid delivery may be done by a static method, whereby the fluid may “puddle” onto the surface.

A dynamic method may also be used where the material is dispensed when the substrate is already in motion. During the early stages for a new process set-up, the exact conditions of rpm and time may need to be established in such a manner to ensure desired coverage of the substrate with minimal or no waste. According to an embodiment, a wafer supporting apparatus, e.g. chuck, may be used that includes a means to contain a substantial fraction of a dispensed liquid volume to the topside of the wafer, which enables improved wafer processing performance that can otherwise be adversely affected by liquid flowing off of the topside of the wafer. For example a chuck may be used that has a raised rim such that when the wafer is placed on the chuck, the rim of the chuck is above the wafer thereby forming a bowl. When such a chuck is employed, a volume of stripping solution may be applied such that it covers and overflows the top surface of the wafer and still maintains contact with the wafer at a depth or thickness sufficient to remove the targeted substance on the wafer, such as for example a photoresist. Moreover, when such a chuck is employed, a portion of the stripping composition may come in contact with a portion of the second or back side of the substrate (or the side opposite the side upon which the substance to be removed is deposited), for example, via capillary action. The chuck can also be designed so that it allows increased heating rates of liquids applied to the topside of a wafer in contact with the chuck in addition to improved spatial uniformity of temperatures of the liquid.

After the wafer is coated with the stripping composition, the stripping composition, the substrate, the chuck or all may be heated. Heating may occur by multiple methods, including convective heating by placement of a heat source within close proximity of the liquid surface, by irradiation with infrared radiation, by conductive heating either by contact to the backside of the wafer or contact directly to the liquid surface by a heat source. According to an embodiment, the stripping composition is heated to a temperature that allows for complete removal of the targeted substance (e.g. photoresist film) within a sufficiently short amount of time. Typically but not necessarily, this requires the stripping composition to be heated above its flash point. According to an embodiment, the stripping composition can be heated to a temperature of from about 15° C. to about 150° C., from about 50° C. to about 120° C., or from about 90° C. to about 110° C. Alternatively, the stripping solution can be heated to a temperature of above 15° C., or above 20° C., or above 30° C., or above 40° C., or above 50° C., or above 60° C., or above 70° C., or above 80° C., above 90° C., or above 100° C., or above 110° C., or above 120° C., or above 130° C., or above 140° C., or above 150° C. According to another embodiment, the stripping solution can be heated to a temperature of below 150° C., or below 140° C., or below 130° C., or below 120° C., or below 100° C., or below 90° C., or below 80° C., below 70° C., or below 60° C., or below 50° C., or below 40° C., or below 30° C., or below 25° C., or below 20° C. According to an embodiment, the temperature variation across the wafer is less than 10° C., less than 7.5° C., or less than 5° C. According to certain embodiments, the stripping composition is preheated wherein heat energy, other than exposure to ambient temperature, is applied to the stripping composition before it is used to coat a substrate. According to other embodiments, the substrate or both the substrate and stripping composition are preheated.

According to an embodiment, the temperature is maintained at the target temperature for a period of time, and the temperature variation from the target temperature can be less than ±5° C., less than ±3° C., or less than ±2° C. According to certain embodiments, a desired temperature or temperature gradient may be maintained or achieved by manipulating a distance between: a) the substrate and/or stripping composition, and b) the heat source. During heating, the wafer can be rotating at a slow rpm, for example, at less than 20 rpm, to improve angular temperature uniformity. A sufficiently short amount of heating time can be less than 10 min for applying heat to the liquid, or less than 8 min, or less than 6 min, or less than 5 min, or less than 4 min, or less than 3 min, or less than 2 min. After heating for a sufficient amount of time, the heat source is removed.

In certain embodiments, the stripping composition is maintained on the substrate at ambient temperature or room temperature, for example, about at 15° C. to about 25° C., for a period of time to allow for dissolution and or release of the organic substance. In other words, in certain embodiments, depending on the nature of, for example, the substance, substrate, and stripping composition, the substrate and or stripping composition is not heated but is maintained at ambient temperature.

According to an embodiment, the process includes agitating the wafer after the wafer has been coated with the stripping composition for a sufficient time to release or dissolve the substance. Agitation can be by any means such as, for example, by mechanical, sonic, or electrical force. According to an embodiment, the wafer is mechanically agitated via spinning the wafer at a speed sufficient to fling-off or substantially remove the stripping composition and released (including dissolved) organic substance. According to certain embodiments, the wafer can be spun at a rate of from about 50 to about 2000 rpm; from about 100 to about 1000 rpm; or from about 150 to about 500 rpm.

According to an embodiment, the process includes, in the event the process cycle does not include a prior agitation, rinsing the wafer to remove stripping composition and the released substance (e.g. photoresist), which may include dissolved substance in the stripping composition, and undissolved substance particles, from the surface of the wafer. In the event the process includes agitating prior to rinsing, the process can include rinsing the wafer to remove residual stripping composition and residual released substance. Rinsing, for example, may comprise one or more of the following including dispensing a solvent or solvent-based mixture on the wafer while the wafer is spinning or stationary, dispensing water on the wafer while the wafer is spinning or stationary, or dispensing other liquid media (including acidic or basic aqueous mixtures, solvent mixtures, semi-aqueous mixtures) to enable removal of stripping composition, substance residue or treatment of the substrate surface.

According to an embodiment, rinsing should occur so as to prevent areas of the wafer from drying before rinsing is complete. If the wafer is allowed to rotate at too high rpm or for too long at a high rpm during rinsing or during a transition between different rinse media, then the liquid thickness on the wafer can become too thin leading to dry spots on the wafer, or it can lead to residues depositing on the wafer. These residues can be organic residues, dissolved photoresist, or metals such as Sn that are dissolved in the rinse media. In these cases, the residues may become very difficult or impossible to remove with further rinsing. Therefore, care should be taken to control the spin speed and spin time during rinsing steps and the transitions between rinsing steps to prevent deposition of organic residues or Sn onto the surface. Additionally, thin spots or dry spots can occur when a liquid has a high interfacial energy with the substrate surface, leading to a high liquid-surface contact angle. In these cases, the high contact angle can lead to de-wetting, where the liquid pulls back from areas of the wafer, which can ultimately lead to deposition of organic residue or dissolved metals onto the surface. De-wetting may be overcome by the addition of, for example, a surfactant or other compound that improves wettability, reduces contact angle, or reduces interfacial energy into rinse media to reduce the liquid-surface interfacial energy and contact angle. The order in which these rinsing steps is applied may vary, and rinsing steps may be repeated multiple times.

As used herein, the term “rinsing agent” includes any solvent that removes the stripping composition, other solution (e.g. aqueous acid or aqueous base solution) and/or released substance to be stripped. Examples of rinsing agents include, but are not limited to, water, pH modified water, acetone, alcohols, for example, isopropyl alcohol and methanol, Dimethylsulfoxide (DMSO), and N-methylpyrrolidone (NMP). Rinsing agents can also include mixtures including surfactants such as, for example, Glycol Palmitate, Polysorbate 80, Polysorbate 60, Polysorbate 20, Sodium Lauryl Sulfate, Coco Glucoside, Lauryl-7 Sulfate, Sodium Lauryl Glucose Carboxylate, Lauryl Glucoside, Disodium Cocoyl Glutamate, Laureth-7. Citrate, Disodium Cocoamphodiacetate, nonionic Gemini surfactants including, for example, those sold under the tradename ENVIROGEM 360, nonionic fluorosurfactants including, for example, those sold under the tradename Zonyl FSO, ionic fluorinated surfactants including, for example, those sold under the tradename Capstone FS-10, Oxirane polymer surfactants including, for example, those sold under the tradename SURFYNOL 2502, and poloxamine surfactants, including, for example, those sold under the tradename TETRONIC 701 and mixtures thereof. Further, the rinsing agent can be water containing a sulfonated monomer or polymer according to the invention in an amount ranging from less than 1% to the limit of solubility. The rinse agent containing the stripping composition and organic substance may be captured at the end of the rinse stage and can be discarded, treated, reused and/or recycled, as appropriate.

According to certain embodiments, rinsing can include a number of various process steps. For example, rinsing processes can include any number of combinations of contacting the substrate with a rinsing agent effective to remove stripping solution and released substance or residual stripping composition and residual released substance, contacting the substrate with an aqueous base solution, contacting the substrate with an aqueous acid solution, contacting the substrate with a rinsing agent effective to remove the aqueous acid solution and/or aqueous base solution from the substrate, and drying the substrate. According to certain embodiments the various rinsing steps can occur in a single bowl. Moreover, the rinsing process can be applied to a substrate that has undergone cleaning in the same bowl or via another process.

According to an embodiment, the process according to the present invention may include drying the substrate. Drying may be accomplished by any art recognized drying method including, but not limited to heat drying, spin drying, gas contact, such as an inert gas, which may contact the substrate in a heated and/or pressurized condition, for example, in the form of an air knife. Drying may also be accomplished chemically by the application of an appropriate drying agent, for example, isopropyl alcohol (IPA) or acetone. Chemical and physical drying techniques may be combined as appropriate. In one embodiment, the substrate is dried chemically by the application of IPA or acetone alone. In another embodiment, the substrate is dried chemically, followed by physical drying. In yet another embodiment, the substrate is chemically dried with, for example, IPA or acetone after physical drying. Residual water should be removed when cleaning substrates including water sensitive components, for example, device architecture including Cu.

According to one embodiment, the substrate may be treated in one or more cycles of coating, heating, agitating and rinsing until the desired level of removal of the substance to be removed is achieved. Moreover, any of the steps may be deleted during subsequent cycles as needed. According to one embodiment, multiple cycles of the same stripping compositions and rinsing agents may be applied. According to another embodiment, multiple cycles may use different stripping compositions in one or more cycles and/or different rinse agents in one or more cycles. In yet another embodiment, the heating profile in different cycles may be changed. When different chemical cycles are used, the holder and/or chamber may be cleaned between cycles. Typically cleaning would involve rinsing with water. Additionally, the chamber and holder can be cleaned with, for example, a water rinse between the processing of different substrates or batches.

According to an embodiment, the process can be used to remove photoresist from a single wafer. Moreover, the process can be repeated for additional wafers, using fresh, unused stripping composition for every wafer. The entire process can be performed with the wafer seated in a single chuck in a single process module. In other words, the process can be carried out as a single stage process. As used herein a “single stage process” refers to a process during which the substrate remains in contact with a single substrate holder throughout the process. According to one embodiment, the holder may remain in a single cleaning chamber or “single bowl” throughout the process or it may rotate or move to one or more of a cleaning chamber, a rinsing chamber and a drying chamber. All unit operations (coating, heating, agitating, rinsing, drying, and other operations such as backside rinse) are performed on the wafer before the wafer is removed from the process module. The wafer may be processed such that once the wafer is seated in the chuck, all operations are performed until the total process is complete and then the wafer is removed from the chuck and the process module. Alternatively, the process may start once the wafer is seated in the chuck, and the wafer may be unseated and reseated from the chuck for specific unit operations but remain in the single process module or single bowl until the total process is complete.

The total time for completing the entire process (the time from when the wafer enters the process module until the wafer leaves the process module) can be less than 20 min per wafer, less than 15 min, less than 12 min, less than 10 min, less than 8 min, less than 7 min, less than 6 min, less than 5 min, or less than 4 min.

Alternatively, some steps of the process may be repeated, and the order in which the steps are performed may not follow the same sequence for all wafers. For example, a wafer may be coated with stripping composition then heated, then rinsed, then dried, then coated a second time with stripping composition, then heated a second time, then rinsed a second time, and finally dried a second time. The entire process may be repeated 2, 3, 4, or more times. Alternatively, the process flow may be different. For example, a wafer may be coated with stripping composition, then heated, then spun to remove stripping composition but not rinsed, then coated a second time with fresh stripping composition, then heated a second time, then rinsed and dried. Alternatively, a different stripping composition may be used to coat the wafer for the 2^{nd} or 3^{rd} or 4^{th} coating step. Compositional differences with respect to the stripping composition can mean either that the stripping composition has the same ingredients in different molar ratios or at least one ingredient present in one but not the other. Alternatively, multiple liquids may be used to rinse the wafer or treat the substrate prior to drying, and these different liquids may be used repeatedly or in varying order.

The inventive process for removing photoresist has advantages compared to immersion based removal of photoresist. For example, the cleaning performance on a wafer-to-wafer basis is more consistent. Each wafer may be treated with fresh, unused stripping composition. Therefore, the composition of the stripping composition can be the same for every wafer without the variation that occurs in immersion tanks due to incorporation of dissolved photoresist and degradation of components. Also, the volume of stripping composition used per wafer clean is less than that used per wafer clean in an immersion process, which can lead to reduced costs.

Another potential advantage of the inventive process is related to the process integration used in wafer level packaging. After removal of the photoresist film, the wafer can be processed to remove Cu field metal around solder pillars. Often, immersion-based removal of photoresist results in a thin film deposition of Sn or Sn oxide on top of the Cu field metal, where the Sn is extracted from the solder and plates onto the Cu. This Sn or Sn oxide thin film is typically removed by a plasma-based etch process. If this Sn or Sn oxide film is not removed, the Cu field metal cannot be removed. In the current invention, photoresist can be removed from wafers without the resulting deposition of the Sn or Sn oxide thin film. Therefore, the process integration can be streamlined to eliminate this Sn or Sn oxide film removal step, leading to a more cost effective integration.

In addition to photoresist and residue removal, the inventive process can be used potentially for other wafer processes used in the fabrication of semiconductor and other microelectronic devices. These processes include but are not limited to, for example, wet etch processes such as Cu field metal etch, photoresist coating and baking, aqueous-based cleaning steps such as sulfuric/peroxide mixture (SPM) cleans.

According to an embodiment the process can employ a chuck having a predominately circular ring having at least two distinct planes connected by a vertical member. Upon the first plane, a wafer can be placed and only the circumferential edge of the wafer is contacted. Backside edges around notches or flats that might be present in the wafer are considered edges and would also make contact with this plane. The perimeter edge of the wafer may or may not contact the vertical member. The second plane may be flush with or extending beyond the topside of the wafer's surface. A means to hold the first and second planes in position also exists that serves to connect the apparatus to a device that has the ability to rotate the apparatus. The chuck may be designed such that the separation between the first and second planes is proportional to the volume of stripping composition that can be contained by the chuck. The chuck can include a protrusion in the vertical member which can serve to rotationally constrain the wafer so that the wafer's rotational velocity matches the rotational velocity of the invention.

### EXAMPLES

The process according to the embodiments described above is further illustrated by, but not limited to, the following examples wherein all percentages given are by weight unless specified otherwise.

### Example 1

This example concerns the removal of a 120 μm thick TOK 50120 dry film negative photoresist from a 300 mm wafer with eutectic Sn/Pb solder pillars. The composition of the stripping composition was 5 wt % tetramethylammonium hydroxide pentahydrate (pTMAH), 23.75 wt % dimethylaminoethanol (DMAE), and 71.25 wt % dimethylsulfoxide (DMSO). The wafer was processed on an EVG-301 RS single wafer photoresist stripping equipment. The wafer was placed in a chuck where ˜96% of the surface area of the backside of the wafer was in contact with air, and the outer diameter of the chuck forms a liquid containment barrier around the perimeter of the wafer. The outer 3 mm radius of the backside of the wafer was in contact with the chuck. This chuck is referred to as the ring chuck. The wafer was covered with 220 mL of the stripping composition. The inner radius of the chuck is ˜4 mm larger than the outer radius of the wafer. The stripping composition fills the total inner diameter of the chuck, i.e., the stripping composition coats the entire top surface of the wafer and extends beyond the total diameter of the wafer to fill the total inner diameter of the chuck. Therefore, the thickness of the stripping composition on top of the wafer was ˜2.95 mm. The stripping composition was then heated by bringing a heater at 250° C. into close proximity (˜1 mm) of the liquid surface. In this manner, the liquid was heated by convective heating. During heating, the temperature was maintained by varying the separation distance between the heater and the liquid surface to control the liquid temperature to a target temperature. In this case, the target temperature for the stripping composition was 105° C. The total time in which heat was applied to the liquid was 6.5 min. After 6.5 min, the heater was removed. The wafer was then spun to fling off liquid from the surface of the wafer at 150 rpm with an acceleration of 200 rpm/sec. The wafer was then immediately rinsed with approximately 50 mL of DMSO at room temperature while rotating at 50 rpm, where the DMSO was dispensed starting in the center and sweeping to the edge of the wafer. Then, the wafer was rinsed with deionized water via fan spray nozzles while rotating at 500 rpm for 20 sec. The wafer was then rinsed with a small volume of IPA and finally dried by spinning the wafer at 1500 rpm for 20 sec. After this process, the photoresist was completely removed from the wafer.

### Example 2

This example concerns the removal of a 120 μm thick Asahi A240 dry film negative photoresist from a 300 mm wafer with Sn/Ag solder pillars. The composition of the stripping composition was 5 wt % tetramethylammonium hydroxide pentahydrate (pTMAH), 23.75 wt % dimethylaminoethanol (DMAE), and 71.25 wt % dimethylsulfoxide (DMSO). The wafer was processed on an EVG-301 RS single wafer photoresist stripping equipment. The wafer was placed in a chuck where ˜96% of the surface area of the backside of the wafer was in contact with air, and the outer diameter of the chuck forms a liquid containment barrier around the perimeter of the wafer. The outer 3 mm radius of the backside of the wafer was in contact with the chuck. The wafer was covered with 220 mL of the stripping composition. The inner radius of the chuck is ˜4 mm larger than the outer radius of the wafer. The stripping composition fills the total inner diameter of the chuck, i.e., the stripping composition coats the entire top surface of the wafer and extends beyond the total diameter of the wafer to fill the total inner diameter of the chuck. Therefore, the thickness of the stripping composition on top of the wafer was ˜2.95 mm. The stripping composition was then heated by bringing a heater at 250° C. into close proximity (˜1 mm) of the liquid surface. In this manner, the liquid was heated by convective heating. During heating, the temperature was maintained by varying the separation distance between the heater and the liquid surface to control the liquid temperature to a target temperature. In this case, the target temperature for the stripping composition was 105° C. The total time in which heat was applied to the liquid was 7 min. After 7 min, the heater was removed. The wafer was then spun to fling off liquid from the surface of the wafer at 150 rpm with an acceleration of 200 rpm/sec. The wafer was then immediately rinsed with approximately 35 mL of DMSO at room temperature while rotating at 50 rpm, where the DMSO was dispensed starting in the center and sweeping to the edge of the wafer. Then, the wafer was rinsed with deionized water via fan spray nozzles while rotating at 500 rpm for 20 sec. The wafer was then rinsed with a small volume of IPA and finally dried by spinning the wafer at 1500 rpm for 20 sec. After this process, the photoresist was completely removed from the wafer.

### Example 3

This example concerns the removal of a 80 μm thick Asahi CX8040 dry film negative photoresist from a 200 mm wafer with Sn/Ag solder pillars. The composition of the stripping composition was 5 wt % tetramethylammonium hydroxide pentahydrate (pTMAH), 23.75 wt % dimethylaminoethanol (DMAE), and 71.25 wt % dimethylsulfoxide (DMSO). The wafer was processed on an EVG-301 RS single wafer photoresist stripping equipment. The wafer was placed in a pin chuck, where the wafer is supported on the backside only by pins, and the edges of the wafer are not contained. The wafer was covered with 50 mL of the stripping composition, and covered the complete top surface area of the 200 mm wafer. Therefore, the thickness of the stripping composition on top of the wafer was ˜1.6 mm. The stripping composition was then heated by bringing a heater at 250° C. into close proximity (˜1 mm) of the liquid surface. In this manner, the liquid was heated by convective heating. During heating, the temperature was maintained by varying the separation distance between the heater and the liquid surface to control the liquid temperature to a target temperature. In this case, the target temperature for the stripping composition was 110° C. The total time in which heat was applied to the liquid was 2 min and 20 sec. After 2 min and 20 sec, the heater was removed. The wafer was then rinsed with 25 mL of DMSO while spinning at 300 rpm. Then, the wafer was rinsed with deionized water via fan spray nozzles while rotating at 1000 rpm for 20 sec. The wafer was then rinsed with a small volume of IPA and finally dried by spinning the wafer at 2000 rpm for 25 sec. After this process, the photoresist was completely removed from the wafer.

### Examples 4-8

Examples 4-8 concern the removal of a 120 μm thick TOK 50120 dry film negative photoresist from several 300 mm wafers with Sn/Ag solder pillars using different processes and/or stripping compositions. Each wafer was processed on an EVG-301 RS single wafer photoresist stripping equipment. Each wafer was placed in a chuck where ˜96% of the surface area of the backside of the wafer was in contact with air, and the outer diameter of the chuck forms a liquid containment barrier around the perimeter of the wafer. The outer 3 mm radius of the backside of the wafer was in contact with the chuck. Each wafer was covered with 220 mL of the stripping composition. The inner radius of the chuck is ˜4 mm larger than the outer radius of the wafer. The stripping composition fills the total inner diameter of the chuck, i.e., the stripping composition coats the entire top surface of the wafer and extends beyond the total diameter of the wafer to fill the total inner diameter of the chuck. Therefore, the thickness of the stripping composition on top of the wafer was ˜2.95 mm. The stripping composition was then heated by bringing a heater at 250° C. into close proximity (˜1 mm) of the liquid surface. In this manner, the liquid was heated by convective heating. During heating, the temperature was maintained by varying the separation distance between the heater and the liquid surface to control the liquid temperature to a target temperature. For examples 4-8, the target temperature for the stripping composition was 105° C. The total time in which heat was applied to the liquid was 8.5 min for examples 4-8. After 8.5 min, the heater was removed. Each wafer was then spun to fling off liquid from the surface of the wafer. To perform this fling-off step, the wafer was accelerated to 150 rpm at 200 rpm/sec followed by a delay of 1 sec. After the 1 sec delay, each wafer was rinsed with deionized water via fan spray nozzles while rotating at 500 rpm for 10 sec. For Examples 4-6 and 8, these wafers were then treated with a 1.14M aqueous solution of LiOH, where the wafer was coated with the LiOH solution while rotating at 10 rpm and allowed to sit for 30 sec. After 30 sec, the wafer was rinsed with deionized water while rotating at 500 rpm for 10 sec. All wafers, except Example 8, were then coated with a 7 wt % aqueous solution of methanesulfonic acid (MSA) while rotating at 10 rpm and allowed to sit for 30 sec. After 30 sec, the wafer was rinsed with deionized water while rotating at 500 rpm for 10 sec. Next, the wafer was rinsed with isopropanol while rotating at 500 rpm for 15 sec. Finally, the wafer was dried by spinning at 1500 rpm for 20 sec. After this process, the photoresist was completely removed from the wafer. The cleaning performance for photoresist removal was measured using a Rudolph NSX-100 optical inspection system. Post-resist strip yield, on a die basis, was recorded. After photoresist removal, each wafer was processed to etch the Cu field metal. Wafers were coated with 100 mL of an aqueous phosphoric acid and hydrogen peroxide mixture at room temperature. Wafers were allowed to sit for 20 min, then rinsed with deionized water and dried. The Cu field metal etch (FME) performance was measured using a Rudolph NSX-100 optical inspection system. Post-FME yield, on a die basis, was recorded. The Cu field metal etch was performed to investigate the Cu surface finish, but it is demonstrative of the capability for using the inventive process to remove photoresist or residue from a wafer and then performing additional wet processes to the same wafer using the same or similar process steps. For example, a wafer can undergo the inventive process to remove photoresist, and then after spin drying, the wafer can be coated with a wet etching solution to remove Cu field metal, then rinsed and dried. In this manner, multiple integration steps can be performed on one tool and in one process bowl.

For Examples 4 and 6-7, the post-resist strip yield was 86-87%, indicative of mostly complete resist removal. In all cases, the defects that resulted in yield loss were typically small residues. Examples 5 and 8 exhibited lower post-resist strip yield than Examples 4 and 6-7. For Examples 5 and 8, the increased defects that resulted in reduced yield were typically surface discoloration and not residue. Therefore, for Examples 4-8, the resist removal performance should be considered equivalent. However, the post-FME yield varied for Examples 4-8, which is more indicative of the real cleaning performance as well as the Cu field metal surface quality. Example 5 exhibited the highest yield after Cu field metal etch. Example 6 exhibited the worst yield.

TABLE 1
Stripping composition and process details used for Examples 4-8,
and post-resist strip and post-FME NSX-100 yield results.

| | Stripping | | Post-Resist | Post- |
|---|---|---|---|---|
| | composition | | Strip | FME |
| Example | (wt %) | Process | Yield | Yield |
| 4 | 5% pTMAH, | After 1^{st} DIW rinse, treat with | 87% | 79% |
| | 23.75% DMAE, | 1.14M LiOH, followed by 2^{nd} | | |
| | 71.23% DMSO, | DIW rinse, followed by | | |
| | 0.02% Silbond- | treatment with 7 wt % MSA, | | |
| | 40 | followed by 3^{rd} DIW rinse, and | | |
| | | final rinse with IPA prior to spin | | |
| | | drying | | |
| 5 | 5% pTMAH, | After 1^{st} DIW rinse, treat with | 65% | 99% |
| | 23.75% DMAE, | 1.14M LiOH, followed by 2^{nd} | | |
| | 71.23% DMSO, | DIW rinse, followed by | | |
| | 0.02% Silbond- | treatment with 7 wt % MSA | | |
| | 40 | (including 0.2% Capstone FS- | | |
| | | 10), followed by 3^{rd} DIW rinse, | | |
| | | and final rinse with IPA prior to | | |
| | | spin drying | | |
| 6 | 5% pTMAH, | After 1^{st} DIW rinse, treat with | 86% | 0% |
| | 23.75% DMAE, | 1.14M LiOH, followed by 2^{nd} | | |
| | 71.25% DMSO | DIW rinse, followed by | | |
| | | treatment with 7 wt % MSA | | |
| | | (including 0.005% Zonyl FSO), | | |
| | | followed by 3^{rd} DIW rinse, and | | |
| | | final rinse with IPA prior to spin | | |
| | | drying | | |
| 7 | 5% pTMAH, | After 1^{st} DIW rinse, treat with 7 wt | 87% | 41% |
| | 23.75% DMAE, | % MSA, followed by 2^{nd} DIW | | |
| | 71.23% DMSO, | rinse, and final rinse with IPA | | |
| | 0.02% Silbond- | prior to spin drying | | |
| | 40 | | | |
| 8 | 5% pTMAH, | After 1^{st} DIW rinse, treat with | 0% | 88% |
| | 23.75% DMAE, | 1.14M LiOH, followed by 2^{nd} | | |
| | 71.23% DMSO, | DIW rinse, and final rinse with | | |
| | 0.02% Silbond- | IPA prior to spin drying | | |
| | 40 | | | |

Silbond-40: 20% ethyl silicate, 3% ethanol, 77% ethyl polysilicates

### Example 9

This example concerns the removal of photoresist after etching a via through a polyimide layer. Vias were patterned in a positive photoresist then etched through the polyimide using an oxygen plasma. Wafers were processed on an EVG-301 RS single wafer photoresist stripping equipment. To strip the remaining photoresist from the underlying polyimide, a single 150 mm wafer was coated with 16.5 mL of stripping composition, resulting in a thickness of 0.95 mm on top of the wafer. The composition of the stripping composition was 5.1 wt % tetramethylammonium hydroxide pentahydrate (pTMAH), 3 wt % monoethanolamine (MEA), 10 wt % 3-methoxy-3-methylbutanol, 81.9 wt % dimethylsulfoxide (DMSO), and 25 ppm EDTA. This stripping process was performed at room temperature. After dispense, the coated wafer sat at room temperature for 30 sec to dissolve the remaining resist. The wafer was then rinsed with 19.5 mL of DMSO while spinning at 300 rpm. After rinsing with DMSO, the wafer was slowed to 10 rpm to prevent the liquid on the wafer from becoming too thin and leading to dry spots on the wafer during the transition to the deionized (DI) water rinse step. Next, the wafer was rinsed for 20 sec with DI water, and then dried by spin drying. The total process time for one wafer was 1 min 55 sec with a total volume usage of stripping composition of 36 mL per wafer. After the process was completed, the resist was completely removed and the polyimide layer remained intact.

### Example 10

This example concerns the removal of post-etch residue after etching features in a GaAs substrate using a plasma etch process. Wafers were processed on an EVG-301 RS single wafer photoresist stripping equipment. To strip the post-etch residue from the wafer, a single 150 mm wafer was coated with 12 mL of stripping composition, resulting in a thickness of 0.7 mm on top of the wafer. The composition of the stripping composition was 5.1 wt % tetramethylammonium hydroxide pentahydrate (pTMAH), 3 wt % monoethanolamine (MEA), 10 wt % 3-methoxy-3-methylbutanol, 81.9 wt % dimethylsulfoxide (DMSO), and 25 ppm EDTA. After coating, the stripping composition was heated using proximity convective heating for a total of 30 sec, reaching a maximum temperature of 80° C. After heating, the wafer was then rinsed with 19.5 mL of DMSO while spinning at 300 rpm. After rinsing with DMSO, the wafer was slowed to 10 rpm to prevent the liquid on the wafer from becoming too thin and leading to dry spots on the wafer during the transition to the DI water rinse step. Next, the wafer was rinsed for 20 sec with DI water, and then dried by spin drying. The total process time for one wafer was 2 min 16 sec with a total volume usage of stripping composition of 31.5 mL per wafer. After the process was completed, the post-etch residue was completely removed from the wafer.

### Example 11

This example concerns the removal of post-etch residue after etching vias into silicon dioxide. Wafers were prepared using AZ 9260 where vias were plasma-etched into silicon dioxide. Wafers were processed on an EVG-301RS single wafer photoresist stripping equipment. To strip the post-etch residue, a 200 mm wafer was coated with 40 mL of stripping composition, resulting in a thickness of stripping composition of ˜1.3 mm on top of the wafer. The composition of the stripping composition was 59.21% DMSO, 35.92% MEA, 4.85% pTMAH. The stripping composition was then heated by bringing a heater at 250° C. into close proximity (˜1 mm) of the liquid surface. In this manner, the liquid was heated by convective heating. During heating, the temperature was maintained by varying the separation distance between the heater and the liquid surface to control the liquid temperature to a target temperature. In this case, the target temperature for the stripping composition was 100° C. The total time in which heat was applied to the liquid was 4 min. After the prescribed time, the heater was removed. After heating, the wafer was rinsed with DI water via fan spray nozzles while rotating at 300 rpm for 20 sec. The water spray was turned on simultaneously with the wafer accelerating to 300 rpm at 500 rpm/sec. Finally, the wafer was dried by spin drying. After the process was completed, the post-etch residue was completely removed from the wafer.

### Example 12

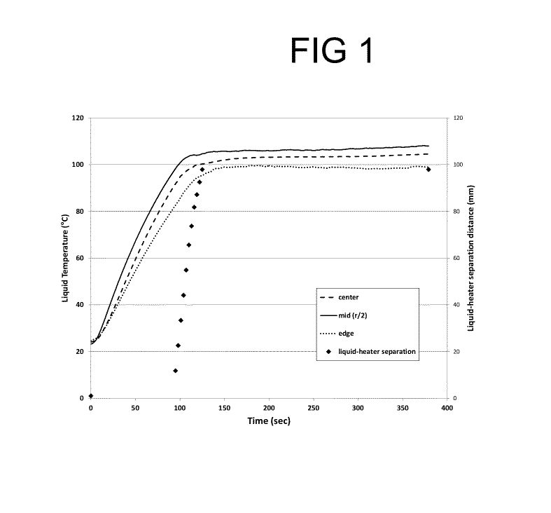

Different methods for heating the stripping composition on the wafer include backside conductive heating, topside convective heating, and topside radiative heating. Each of these methods has been investigated for their ability to heat the stripping composition on the wafer. For Example 12, liquid on a bare 300 mm Si wafer was heated using top-down convective heating, where the heater was at a temperature of 250° C. The wafer was placed in the ring chuck and covered with 220 mL of DMSO, resulting in a thickness of DMSO of ˜2.95 mm on top of the wafer. The heater was brought within 1 mm of the top surface of the ring chuck, which also corresponded to 1 mm from the top surface of the DMSO. The heater was kept at this position for 1 min 35 sec then slowly stepped away from the liquid surface to an equilibrium position that was 98 mm from the top surface of the DMSO. FIG. 1 shows the measured liquid temperature at 3 positions on the wafer and the liquid-heater separation distance vs. time. The liquid temperature was measured with thermocouples that were adhered to the surface of the wafer at three positions, the center of the wafer, the edge of the wafer, and the middle radius (r/2) of the wafer. The initial heating rate and average equilibrium temperature for the three positions are shown in Table 2. The average initial heating rate for the whole wafer was 0.76° C./sec. The range in average temperature across the wafer was 7.7° C. For a given position, the range in the equilibrium temperature was less than 3° C.

TABLE 2
Initial heating rate for the first 90 sec, average equilibrium
temperature for the three positions, and equilibrium temperature
range for the three positions on the wafer for top-down convective
heating with the heater at 250° C.
Equilibrium temperature was measured from 150 sec to end of run.

| | | | Equilibrium |
|---|---|---|---|
| | Initial heat rate | Average equilibrium | temperate range |
| Position | (° C./sec) | Temperature (° C.) | (° C.) |
| Center | 0.78 | 103.5 | 2.6 |
| Mid (r/2) | 0.84 | 106.6 | 2.6 |
| Edge | 0.66 | 98.9 | 2.6 |

### Example 13

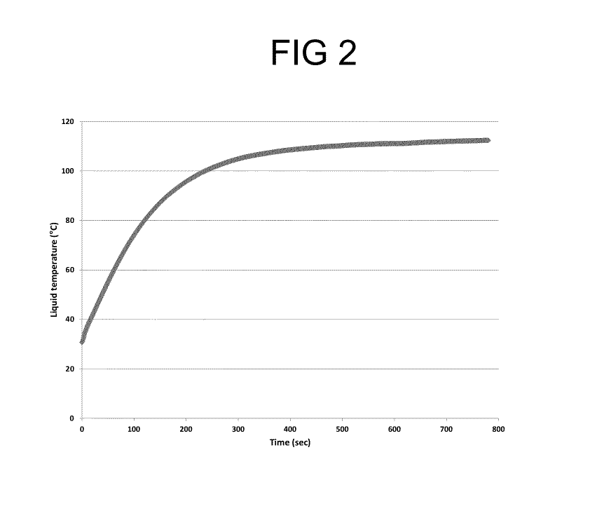

For Example 13, liquid was heated using top-down convective heating, where the heater was at a temperature of 150° C. A coupon from a 300 mm wafer (3.7 cm×3.7 cm×0.775 mm) was placed inside a stainless steel holder with a well with a volume of 2.7 mL. 1.8 mL of DMSO was used to cover the coupon, resulting in a thickness of DMSO of ˜2 mm on top of the coupon. The heater was brought within 1 mm of the top surface of the holder, which also corresponded to 1 mm from the top surface of the DMSO. The heater was kept at this position for the entire run of 780 sec. FIG. 2 shows the measured liquid temperature inside the coupon holder. The average heating rate was 0.38° C./sec for the first 150 sec. The average temperature and range over the last 420 sec was 110.6° C. and 5° C., respectively.

### Example 14

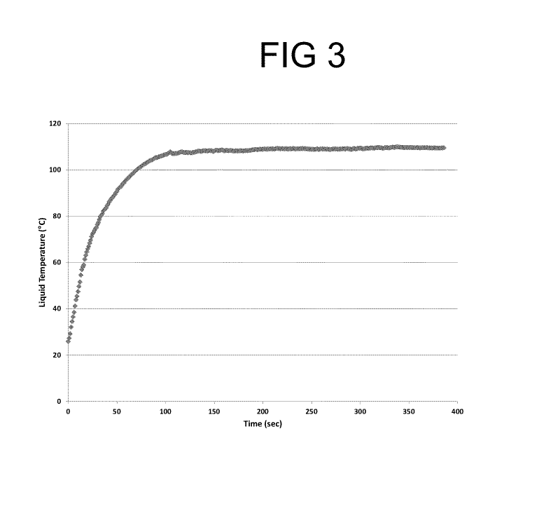

For Example 14, liquid was heated using bottom-up conductive heating, where the heater was at a temperature of 115° C. A coupon from a 300 mm wafer (3.7 cm×3.7 cm×0.775 mm) was placed inside a stainless steel holder with a well with a volume of 2.7 mL. 1.8 mL of DMSO was used to cover the coupon, resulting in a thickness of DMSO of ˜2 mm on top of the coupon. The holder was placed directly on top of the heater. FIG. 3 shows the measured liquid temperature inside the coupon holder. The average initial heating rate was 1.5° C./sec for the first 40 sec. The average temperature and range over the last 420 sec was 108.8° C. and 3.3° C., respectively.

### Example 15

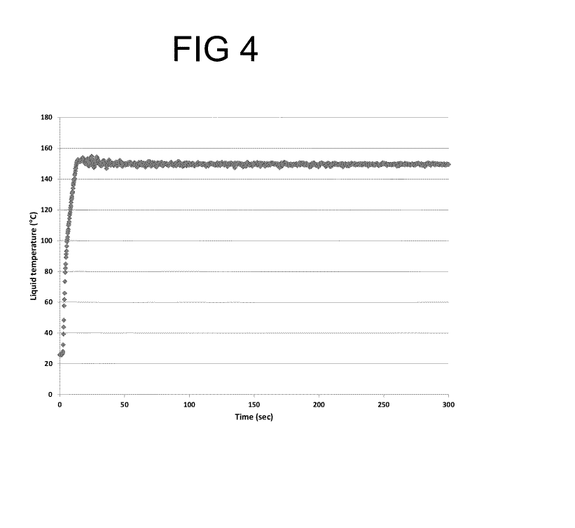

For Example 15, liquid was heated on a wafer using top-down radiative heating. A bare 200 mm Si wafer was placed on a bench top and covered with 50 mL of stripping composition. The stripping composition was 45 wt % n-methylpyrrolidone, 11.25 wt % tetramethylammonium hydroxide pentahydrate, 33.75 wt % diethylene glycol, 10 wt % diethylene glycol diester of 5-sodiosulfoisophthalic acid. The infrared radiation was provided by a linear array of medium-wave carbon emitters. The IR emitters were 75 mm above the wafer surface. Power was supplied to the IR emitters to irradiate and heat the liquid on the wafer. The liquid temperature was measured and used to control the IR power using a PID controller to maintain the liquid temperature at the target of 150° C. FIG. 4 shows the measured liquid temperature in the center of the wafer. The average initial heating rate was 10.6° C./sec for the first 10 sec. The average temperature and range over the last 285 sec was 149.7° C. and 7.9° C., respectively.

Although embodiments have been described in language specific to methodological acts, the embodiments are not necessarily limited to the specific acts described. Rather, the specific acts are disclosed as illustrative forms of implementing the embodiments.

What is claimed is:

1. A process for removing a substance from a substrate comprising:
a. providing a substrate having a first side on which is disposed a substance and a second side;
b. contacting the first side of the substrate with a stripping composition to a thickness sufficient to coat at least a portion of the first side of the substrate;
c. heating the substrate, stripping composition or both to a temperature and for a time sufficient to release the substance from at least a portion of the substrate;
d. agitating the substrate through a mechanical, sonic, or electrical force to substantially remove the stripping composition and released substance,
wherein at least a portion of said second side is not exposed to the stripping composition.

2. The process according to claim 1, further comprising:
e. rinsing the substrate.

3. The process according to claim 2, further comprising:
f. drying the substrate.

4. The process according to claim 1, wherein the thickness of the stripping composition at any location on the substrate is between about 0.5 mm to about 5.0 mm.

5. The process of claim 1, wherein the process is carried out in a single bowl.

6. The process of claim 1, wherein the substrate is preheated before coating with the stripping composition.

7. The process of claim 1, wherein the stripping composition is preheated before it is coated on the substance.

8. The process according to claim 1, wherein the substrate is subjected to at least one additional cycle of a.-d.

9. The process according to claim 8, wherein fresh stripping composition is used in the at least one additional cycle.

10. The process according to claim 8, wherein the composition of the stripping composition used in the at least one additional cycle is different from the composition of the stripping composition used in a previous cycle.

11. The process according to claim 2, wherein the substrate is subjected to at least one additional cycle of a.-e.

12. The process according to claim 3, wherein the substrate is subjected to at least one additional cycle of a.-f.

13. The process according to claim 1, wherein the agitating is via spinning.

14. A process for removing a substance from a substrate comprising:
a. providing a substrate having a first side on which is disposed a substance and a second side;
b. contacting the first side of the substrate with a stripping composition to a thickness sufficient to coat a least a portion of the first side of the substrate and for a time sufficient to release the substance; and
c. agitating the substrate through a mechanical, sonic, or electrical force to substantially remove the stripping composition and released substance,
wherein at least a portion of said second side is not exposed to the stripping composition.

15. The process according to claim 14, further comprising:
d. rinsing the substrate.

16. The process according to claim 15, further comprising:
e. drying the substrate.

17. The process according to claim 14, wherein the thickness of the stripping composition is between about 0.5 mm to about 5.0 mm.

18. The process according to claim 14, wherein the substrate is subjected to at least one additional cycle of a.-c.

19. The process according to claim 18, wherein fresh stripping composition is used in the at least one additional cycle.

20. The process according to claim 18, wherein the composition of the stripping composition used in the additional cycle is different from the composition of the stripping composition used in a previous cycle.

21. The process according to claim 15, wherein the substrate is subjected to at least one additional cycle of a.-d.

22. The process according to claim 16, wherein the substrate is subjected to at least one additional cycle of a.-e.

23. The process according to claim 14, wherein said agitating is via spinning.

24. The process of claim 14, wherein the substrate is preheated before coating with the stripping composition.

25. The process of claim 14, wherein the stripping composition is preheated before it is coated in the substrate.

26. A process for rinsing a substrate comprising:
a. providing a substrate having a first side on which is disposed a substance and a second side;
b. removing the substance from the substrate;
c. contacting the first side of the substrate with an aqueous base solution;
d. contacting the first side of the substrate with a rinsing agent effective to remove said aqueous base solution from the substrate; and
e. drying said substrate,
wherein a.-e. occur in a single bowl, and
at least a portion of said second side is not exposed to the aqueous base solution composition.

27. The process according to claim 26, wherein the substrate is agitated through a mechanical, sonic, or electrical force during at least one of a.-d.

28. The process according to claim 27, wherein said agitating is via spinning.

29. A process for rinsing a substrate comprising:
a. providing a substrate having a first side on which is disposed a substance and a second side;
b. removing the substance from the substrate;
c. contacting the first side of the substrate with an aqueous acid solution;
d. contacting the substrate with a rinsing agent effective to remove said aqueous acid solution from the substrate; and
e. drying said substrate,
wherein a.-e. occur in a single bowl, and
at least a portion of said second side is not exposed to the aqueous acid solution composition.

30. The process according to claim 29, wherein the substrate is agitated through a mechanical, sonic, or electrical force during at least one of a.-d.

31. The process according to claim 30, wherein said agitating is via spinning.

32. A process for rinsing a substrate comprising:
a. providing a substrate having a first side on which is disposed a substance and a second side;
b. removing the substance from the substrate;
c. contacting the substrate with an aqueous base solution;
d. contacting the substrate with a rinsing agent;
e. contacting the substrate with an aqueous acid solution;
f. contacting the substrate with a rinsing agent; and
g. drying said substrate
wherein at least c.-g. occur in a single bowl, and
at least a portion of said second side is not exposed to the aqueous base solution or the aqueous acid solution composition.

33. The process according to claim 32, wherein the substrate is agitated through a mechanical, sonic, or electrical force during at least one of a.-g.

34. The process according to claim 33, wherein said agitating is via spinning.

35. The process according to claim 32, wherein at least a.-g. occur in a single bowl.
